(19) United States
(12) Patent Application Publication
(10) Pub. No.: US 2021/0174780 A1
(43) Pub. Date: Jun. 10, 2021

(54) HOLEY PLATE AND COMPOSITE PANEL FOR SOUND ABSORPTION AND SOUND INSULATION USING THE SAME

(71) Applicants: HYUNDAI MOTOR COMPANY, Seoul (KR); KIA MOTORS CORPORATION, Seoul (KR); NVH KOREA, INC., Ulsan (KR)

(72) Inventors: Jae Gi Sim, Seoul (KR); Hong Jae Kim, Hwaseong-si (KR); Jong Hyun Ryu, Ansan-si (KR)

(21) Appl. No.: 17/010,104

(22) Filed: Sep. 2, 2020

(30) Foreign Application Priority Data
Dec. 10, 2019 (KR) 10-2019-0163602

(51) Int. Cl. G10K 11/162; B32B 3/26; B32B 3/30

(52) U.S. Cl. CPC G10K 11/162; B32B 3/266; B32B 2307/102; B32B 2607/00; B32B 3/30

(57) ABSTRACT

Disclosed are a holey plate, which improves the shape of punched holes so as to increase sound absorbing and insulating efficiency and durability, and a composite panel for sound absorption and sound insulation using the same. The holey plate used in the composite panel includes a base part, first bent parts configured to be bent from designated regions of the base part and to extend to be inclined so as to form a plurality of first punched holes by punching the designated regions of the base part in a thickness direction, and second bent parts configured to be bent from the first bent parts and to extend to be inclined so as to form second punched holes extending from the first punched holes, an angle of the second bent parts with the base part being smaller than an angle of the first bent parts with the base part.

### CROSS REFERENCE TO RELATED APPLICATIONS

This application claims the priority benefit of Korean Patent Application No. 10-2019-0163602, filed on Dec. 10, 2019 in the Korean Intellectual Property Office, the disclosure of which is incorporated herein by reference.

### BACKGROUND

### 1. Field

The present disclosure relates to a holey plate and a composite panel for sound absorption and sound insulation using the same and, more particularly, to a holey plate, which may improve the shape of punched holes so as to increase sound absorbing and insulating efficiency and durability, and a composite panel for sound absorption and sound insulation using the same.

### 2. Description of the Related Art

A heat protector applied to vehicles uses a composite panel generally including aluminum plates and a sound absorbing and insulating material. Such a composite panel has a structure in which the sound absorbing and insulating material fills a gap between two aluminum plates, and in this structure, the aluminum plates serve to compensate for stiffness and the sound absorbing and insulating material serves to exhibit heat insulation, sound absorption and sound insulation effects.

Here, if simple flat-type aluminum plates are used, stiffness is insufficient, and thus, embossed aluminum plates having irregularities are used to compensate for stiffness.

For example, the conventional plate may be configured such that convex cells having a hexagonal shape are arranged in a honeycomb structure so as to maximize stiffness, but this structure has low processability and thus causes difficulty in manufacturing a heat protector having a desired shape.

Further, use of only the composite panel, in which the sound absorbing and insulating material fills the gap between the aluminum plates, does not achieve sufficient sound absorbing and insulating performance.

Therefore, in order to compensate for sound absorbing and insulating performance, there was an attempt to use a holey plate having punched holes by perforating an aluminum plate, but formation of the punched holes having a simple shape has a limit in improvement in sound absorbing and insulating performance.

The above description has been provided to aid in understanding of the background of the present disclosure and should not be interpreted as conventional technology known to those skilled in the art.

### SUMMARY

Therefore, the present disclosure has been made in view of the above problems, and it is an object of the present disclosure to provide a holey plate, which may optimize the shape of punched holes so as to increase sound absorbing and insulating efficiency and durability, and a composite panel for sound absorption and sound insulation using the same.

In accordance with an aspect of the present disclosure, the above and other objects can be accomplished by the provision of a holey plate used in a composite panel for sound absorption and sound insulation, the holey plate including a part, first bent parts configured to be bent from designated regions of the base part and to extend to be inclined so as to form a plurality of first punched holes by punching the designated regions of the base part in a thickness direction, and second bent parts configured to be bent from the first bent parts and to extend to be inclined so as to form second punched holes extending from the first punched holes, an angle of the second bent parts with the base part being smaller than an angle of the first bent parts with the base part.

A thickness of the base part may be 35-500 μm.

A maximum inner diameter of the second punched holes may be 0.15-1.5 mm.

A maximum inner diameter of the first punched holes and a maximum inner diameter of the second punched holes may satisfy an Equation 1, below:

1.5×D2≤D1≤5.0×D2 [Equation 1]

where D1 may indicate the maximum inner diameter of the first punched holes and D2 may indicate the maximum inner diameter of the second punched holes.

The maximum inner diameter of the second punched holes and a height of the first bent parts may satisfy an Equation 2, below:

0.3×D2≤H≤2.0×D2 [Equation 2]

where D2 may indicate the maximum inner diameter of the second punched holes and H may indicate the height of the first bent parts.

The angle of the first bent parts with the base part may be 120-170°.

The first bent parts may be formed to have a dome or conical shape.

The base part may be a plate-type.

In accordance with another aspect of the present disclosure, there is provided a composite panel for sound absorption and sound insulation including a holey plate including a base part, first bent parts configured to be bent from designated regions of the base part and to extend to be inclined so as to form a plurality of first punched holes by punching the designated regions of the base part in a thickness direction, and second bent parts configured to be bent from the first bent parts and to extend to be inclined so as to form second punched holes extending from the first punched holes, an angle of the second bent parts with the base part being smaller than an angle of the first bent parts with the base part, and a sound absorbing material configured to be bonded to a surface of the holey plate in a direction in which the first bent parts and the second bent parts are bent, among both surfaces of the holey plate, so as to absorb and insulate noise.

The sound absorbing material may be bonded to the surface of the holey plate in the direction in which the first bent parts and the second bent parts are bent, and outer circumferential surfaces of the first bent parts and the second bent parts, but may not be disposed in the first punched holes and the second punched holes formed in inner circumferential regions of the first bent parts and the second bent parts, and the sound absorbing material may close ends of the second punched holes.

The holey plate may be formed of one of aluminum and stainless steel to have a thickness of 35-500 μm.

The sound absorbing material may include one or more of a thermosetting foaming body configured to have a density of 7-100 kg/cm³ and a thickness of 5-50 mm, and felt including one or more of an olefin-based material, cotton fiber and an inorganic material and configured to have a unit weight of 100-2000 g/m².

The base part may be a plate-type.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a cross-sectional view of a holey plate according to one embodiment of the present disclosure;

FIG. 2 is a view illustrating a punching process for manufacturing the holey plate according to one embodiment of the present disclosure;

FIGS. 3A and 3B are actual photographs of the holey plate according to one embodiment of the present disclosure;

FIG. 4A is a cross-sectional view of a composite panel for sound absorption and sound insulation according to one embodiment of the present disclosure;

FIG. 4B is a cross-sectional view of a conventional composite panel for sound absorption and sound insulation;

FIG. 5 is a graph representing peel strength of the holey plate from a sound absorbing material depending on an angle between a base part and first bent parts;

FIG. 6 is a graph comparatively representing sound absorption depending on the weight of the sound absorbing material per unit area;

FIGS. 7A, 7B, and 7C are graphs comparatively representing sound absorption depending on whether or not the holey plate is present and the kind of the holey plate; and

FIG. 8 is a graph comparatively representing sound insulation depending on the kind of the holey plate.

### DETAILED DESCRIPTION

Reference will now be made in detail to the preferred embodiments of the present disclosure, examples of which are illustrated in the accompanying drawings. However, the present disclosure is not limited to the embodiments which will be disclosed hereinafter and thus it will be understood that various equivalent modifications of the embodiments will become apparent to those skilled in the art, and the embodiments of the present disclosure are provided only to completely disclose the disclosure. Wherever possible, the same reference numbers will be used throughout the drawings to refer to the same or like parts.

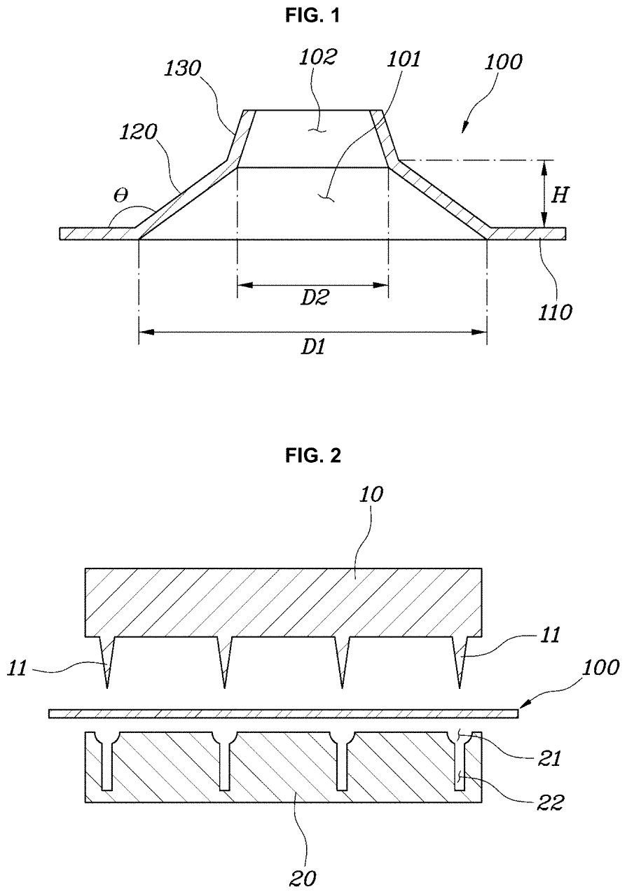

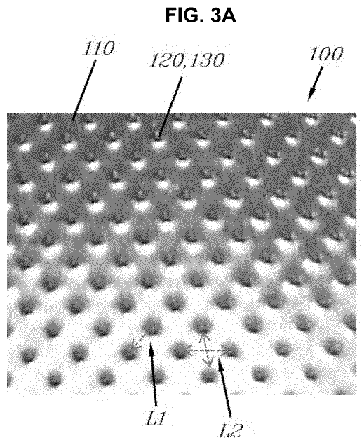

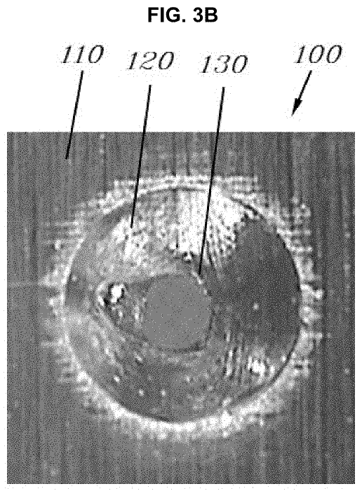

FIG. 1 is a cross-sectional view of a holey plate according to one embodiment of the present disclosure, FIG. 2 is a view illustrating a punching process for manufacturing the holey plate according to one embodiment of the present disclosure, and FIGS. 3A and 3B are actual photographs of the holey plate according to one embodiment of the present disclosure.

A holey plate 100 according to one embodiment of the present disclosure is a holey plate used in a composite panel for sound absorption and sound insulation.

The holey plate 100 according to the present disclosure, which is applied to a composite panel for sound absorption and sound insulation, includes a base part 110, first bent parts 120 which are bent from designated regions of the base part 110 and extend to be inclined so as to form a plurality of first punched holes 101 by punching the designated regions of the base part 110 in a thickness direction, and second bent parts 130 which are bent from the first bent parts 120 and extend to be inclined so as to form second punched holes 102 extending from the first punched holes 101, an angle of the second bent parts 130 with the base part 110 is smaller than an angle of the first bent parts 120 with the base part 110.

The base part 110 is a plate serving as a base for forming the holey plate 100, and may be formed of a material, such as aluminum or stainless steel (SUS).

Further, the thickness of the base part 110 may be 35-500 μm.

If the thickness of the base part 110 is less than 35 μm, stiffness of the holey plate 100 is excessively low and thus a stiffness improvement effect due to generation of the first bent parts 120 and the second bent parts 130 is not exhibited, and if the thickness of the base part 110 exceeds 500 μm, stiffness of the holey plate 100 is excessively high and thus a stiffness improvement effect due to generation of the first bent parts 120 and the second bent parts 130 is not exhibited.

Here, the base part 110 may be formed of a flat plate. Of course, the base part 110 is not limited to a flat plate, and may be formed of an embossed plate having embossed irregularities formed throughout the entirety thereof so as to compensate for stiffness, for example.

The first bent parts 120 and the second bent parts 130 are continuously formed while punching the base part 110 in the thickness direction so as to form the punched holes 101 and 102 through the base part 110, and the first bent parts 120 and the second bent parts 130 are distinguished from each other by adjusting the angles of the first bent parts 120 and the second bent parts 130.

In more detail, the first bent parts 120 are bent from the base part 110 into a dome or conical shape. Thereby, the inner circumferential regions of the first bent parts 120 form the first punched holes 101. Here, since the first bent parts 120 are formed by bending the base part 110 into the dome or conical shape, the first punched hole 101 in a region contacting the base part 110 has the maximum inner diameter D1, and as a region of the first punched hole 101 is farther away from the base part 110, the inner diameter of the first punched hole 101 in the region is gradually decreased. Therefore, the first punched holes 101 have the dome or conical shape due to the first bent parts 120, and a resonance effect caused by such a shape may be expected.

Further, the second bent parts 130 extend from the ends of the first bent parts 120 and are bent. Thereby, the inner circumferential regions of the second bent parts 130 form the second punched holes 102. Here, the second bent parts 130 are formed such that the angle of the second bent parts 130 with the base part 110 is smaller than the angle of the first bent parts 120 with the base part 110. Therefore, the second punched hole 102 in a region contacting the first bent part 120 has the maximum inner diameter D2, and as a region of the second punched hole 102 is farther away from the first bent part 120, the inner diameter of the second punched hole 102 in the region is gradually decreased. Thus, the second bent parts 130 extend from the first bent parts 120 so as to form an undercut shape, thereby being capable of improving bonding strength between the holey plate 100 and a sound absorbing material 200 when the sound absorbing material 200 is bonded to the holey plate 100.

In the present disclosure, the diameters of the first punched holes 101 and the second punched holes 102 and the height H of the first bent parts 120 are limited, thereby improving sound absorption of the holey plate 100.

For this purpose, the maximum inner diameter D2 of the second punched holes 102 may be 0.15-1.5 mm.

If the maximum inner diameter D2 of the second punched holes 102, i.e., the diameter of contact regions between the first punched holes 101 and the second punched holes 102, is less than 0.15 mm, the first punched holes 101 and the second punched holes 102 are excessively small and thus sound absorption performance may be lowered due to clogging of the second punched holes 102 during a process for forming the holey plate 100, and if the maximum inner diameter D2 of the second punched holes 102 exceeds 1.50 mm, the first punched holes 101 and the second punched holes 102 are excessively large and thus the resonance effect due to the inner walls of the first bent parts 120 may be reduced and the sound absorption rate improvement effect may be reduced.

Further, the maximum inner diameter D1 of the first punched holes 101 and the maximum inner diameter D2 of the second punched holes 102 may satisfy the following Equation 1.

1.5×D2≤D1≤5.0×D2 [Equation 1]

If the maximum inner diameter D1 of the first punched holes 101, i.e., the diameter of contact regions between the first punched holes 101 and the base part 110, is less than the suggested range, resonance regions become smaller and thus sound absorption performance caused by the resonance effect may be lowered, and if the maximum inner diameter D1 of the first punched holes 101 exceeds the suggested range, the number of the first punched holes 101 per unit area is greatly reduced and thus sound absorption may be lowered.

Further, the maximum inner diameter D2 of the second punched holes 102 and the height H of the first bent parts 120 may satisfy the following Equation 2.

0.3×D2≤H≤2.0×D2 [Equation 2]

If the height H of the first bent parts 120 is less than the suggested range, the resonance regions become smaller and thus sound absorption performance caused by the resonance effect may be lowered, and if the height H of the first bent parts 120 exceeds the suggested range, the maximum inner diameter D1 of the first punched holes 101 and the maximum inner diameter D2 of the second punched holes 102 become similar to each other and thus the resonance effect may be reduced and sound absorption performance may be lowered.

The angle θ of the first bent parts 120 with the base part 110 may be 120-170°.

If the angle θ of the first bent parts 120 with the base part 110 is less than 120°, the height of the first bent parts 120 is increased, the dome or conical shape of a desired level is not formed and thus bonding strength between the holey plate 100 and the sound absorbing material 200 may not be ensured, and if the angle θ of the first bent parts 120 with the base part 110 exceeds 170°, it is difficult to embody the embossed shape of the base part 110 and thus bonding strength between the holey plate 100 and the sound absorbing material 200 may not be ensured.

In order to form the first bent parts 120 and the second bent parts 130 in the base part 110, as shown in FIG. 2, a punching roll 10 having punching pins 11 and a backup roll 20 having first pin holes 21 and second pin holes 22 having shapes corresponding to the first bent parts 120 and the second bent parts 130 are prepared. Here, the first pin holes 21 having a dome shape and the second pin holes 22 communicating with the first pin holes 21 are formed.

Thereafter, the holey plate 100, i.e., the base part 110 which is not punched, is disposed between the punching roll 10 and the backup roll 20, and the punching roll 10 and the backup roll 20 are brought into contact with each other. Then, the punching pins 11 penetrate the base part 110 and are inserted into the first pin holes 21 and the second pin holes 22 and thus some regions of the base part 110 are punched, and regions around the punched regions of the base part 110 are deformed into a shape corresponding to the first pin holes 21 so as to form the first bent parts 120, and the ends of the first bent parts 120 protrude into an undercut shape corresponding to the second pin holes 22 so as to form the second bent parts 130.

Such formation of the second bent parts 130 having the undercut shape may improve bonding strength between the holey plate 100 and the sound absorbing material 200 when the sound absorbing material 200 is bonded to the holey plate 100.

In the holey plate 100 prepared by the above-described process, the first and second punched holes 101 and 102 formed by the first bent parts 120 and the second bent parts 130 are arranged in a designated pattern.

For example, as shown in FIG. 3A, the first and second punched holes 101 and 102 may be arranged in a repetitive diamond pattern.

Here, the first and second punched holes 101 and 102 may be formed such that the minimum inner diameter of the second punched holes 102 is 0.19-0.22 mm, a distance L1 from the center of one first or second punched hole 101 or 102 to the center of the first or second punched hole 101 or 102, which is disposed adjacent to the former in a diagonal direction, is within the range of 1.42-1.45 mm, and a distance L2 from the center of one first or second punched hole 101 or 102 to the center of the first or second punched hole 101 or 102, which is disposed adjacent to the former in a horizontal or vertical direction, is within the range of 2.03-2.06 mm.

Hereinafter, a composite panel for sound absorption and sound insulation according to one embodiment of the present disclosure will be described.

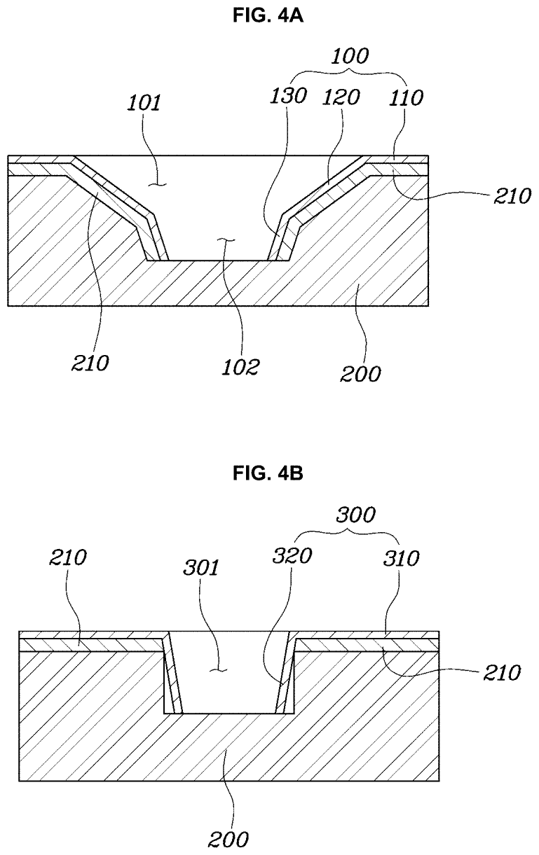

FIG. 4A is a cross-sectional view of the composite panel for sound absorption and sound insulation according to one embodiment of the present disclosure.

As shown in FIG. 4A, the composite panel for sound absorption and sound insulation according to one embodiment of the present disclosure includes the above-described holey plate 100, and the sound absorbing material 200 which is bonded to a surface of the holey plate 100 located in a direction in which the first bent parts 120 and the second bent parts 130 are bent, among both surfaces of the holey plate 100, so as to absorb and insulate noise. Here, the sound absorbing material 200 is bonded to the surface of the holey plate 100 by an adhesive 210.

Particularly, since the first bent parts 120 and the second bent parts 120 having the undercut shape are formed in the base part of the holey plate 100, when the sound absorbing material 200 is bonded to the holey plate 100, the second bent parts 130 are fixed to the sound absorbing material 200 and thus bonding strength between the holey plate 100 and the sound absorbing material 200 may be improved.

Further, since the angle of the first bent parts 120 with the base part 110 and the angle of the second bent parts 130 with the base part 110 vary in stages and form a gentle slope, the holey plate 100 is properly bonded to the sound absorbing material 200 by the adhesive 210 and thus bonding strength between the holey plate 100 and the sound absorbing material 200 may be improved.

In addition, the sound absorbing material 200 is bonded to the surface of the holey plate 100 in the direction in which the first bent parts 120 and the second bent parts 130 are bent, and the outer circumferential surfaces of the first bent parts 120 and the second bent parts 130, but is not disposed in the first punched holes 101 and the second punched holes 102 formed in the inner circumferential regions of the first bent parts 120 and the second bent parts 130, and the sound absorbing material 200 closes the ends of the second punched holes 102. Therefore, the resonance effect through vacant spaces formed by the first punched holes 101 and the second punched holes 102 may be expected.

FIG. 4B is a cross-sectional view of a conventional composite panel for sound absorption and sound insulation, and punched holes 301 having a simple vertical shape are formed in a base part 310 of a holey plate 300 so that bent parts 320 are formed to have an almost straight linear shape. Further, a sound absorbing material 200 is bonded to one surface of the base part 310 by an adhesive 210.

In this case, since an angle of the bent parts 320 with the base part 310 exceeds 170°, the sound absorbing material 200 may not be normally bonded to regions of the base part 310 in which the bent parts 320 are formed, and thereby, bonding strength between the holey plate 300 and the sound absorbing material 200 may be lowered.

The sound absorbing material 200 may use a thermosetting foaming body having a density of 7-100 kg/cm³ and a thickness of 5-50 mm. Here, polyurethane, melamine or phenol may be used as the thermosetting foaming body.

When the density of the thermosetting foaming body is less than 7 kg/cm³, the strength of the thermosetting foaming body is insufficient and thus it may be impossible to form the composite panel for sound absorption and sound insulation after the sound absorbing material 200 is bonded to the holey plate 300, and when the density of the thermosetting foaming body exceeds 100 kg/cm³, the improvement effect of sound absorption and sound insulation may be poor.

Further, when the thickness of the sound absorbing material 200 is less than 5 mm, bonding force of the sound absorbing material 200 with the holey plate 300 may be insufficient, and when the thickness of the sound absorbing material 200 exceeds 50 mm, increase in the improvement effect of sound absorption and sound insulation may be poor.

Alternatively, the sound absorbing material 200 may use felt which includes one or more of an olefin-based material, cotton fiber and an inorganic material and has a unit weight of 100-2000 g/m². Here, a fiber-type, powder-type or liquid-type binder may be used.

When the unit weight of the felt is less than 100 g/m², side effects, such as vibration of the holey plate 300 when the sound absorbing material 200 is bonded to the holey plate 300, may be encountered, and when the unit weight of the felt exceeds 2000 g/m², increase in the improvement effect of sound absorption and sound insulation may be poor.

Next, the present disclosure will be described through examples and comparative examples.

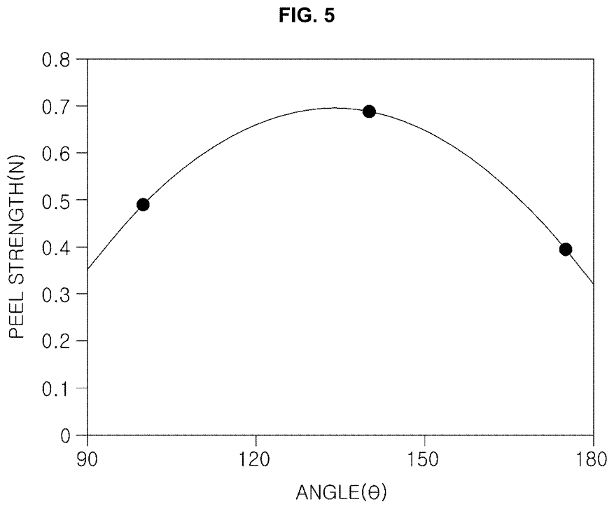

First, a test in which peel strength of a holey plate from a sound absorbing material depending on an angle between a base part and first bent parts is detected was performed, and test results are represented in FIG. 5.

FIG. 5 is a graph representing peel strength of the holey plate from the sound absorbing material depending on the angle between the base part and the first bent parts.

Holey plate samples were prepared by forming first bent parts and second bent parts according to the present disclosure in an aluminum (Al) plate having a thickness of 125 μm. Here, the holey plate samples were prepared by changing the angle between the base part and the first bent parts.

Thereafter, PU foam of 18K and 25t serving as the sound absorbing material was bonded to the prepared holey plate samples using a holt melt film of 30 g/m² serving as an adhesive.

As shown in FIG. 5, it may be confirmed that peel strength of the holey plate from the sound absorbing material is the highest when the angle between the base part and the first bent parts is about 140°, and is then reduced as the angle between the base part and the first bent parts is decreased or increased from 140°.

Therefore, it may be understood that in order to maintain bonding strength of a desired level in consideration of a punching process for forming the first bent parts and the structural shapes of the punching roll and the backup roll used in the punching process, the angle θ of the first bent parts with the base part may be 120-170°.

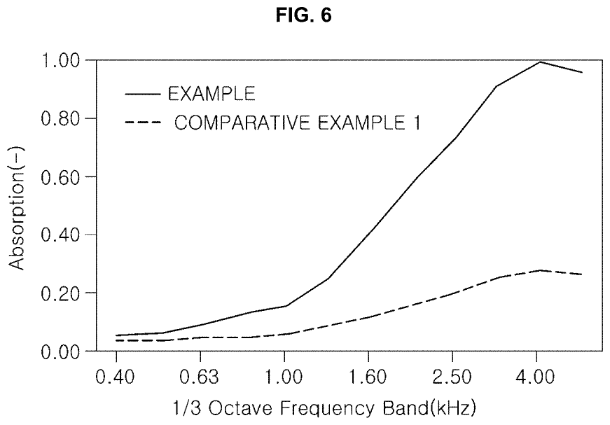

Next, a test in which sound absorption depending on the weight of a sound absorbing material per unit area is detected was performed, and test results are represented in FIG. 6.

FIG. 6 is a graph comparatively representing sound absorption depending on the weight of the sound absorbing material per unit area.

Holey plate samples were prepared by forming first bent parts and second bent parts according to the present disclosure in an aluminum (Al) plate having a thickness of 125 μm.

Thereafter, PU foam of 18K and 25t serving as the sound absorbing material was bonded to the prepared holey plate samples using a holt melt film of 30 g/m² serving as an adhesive. Here, PU foam having a weight per unit area of 450 g/m² was used as the sound absorbing material in an example, and PU foam having a weight per unit area of 90 g/m² was used as the sound absorbing material in comparative example 1.

As shown in FIG. 6, it may be confirmed that sound absorption of the example having the greater weight per unit area, i.e., unit weight, was high in all frequency bands compared to comparative example 1.

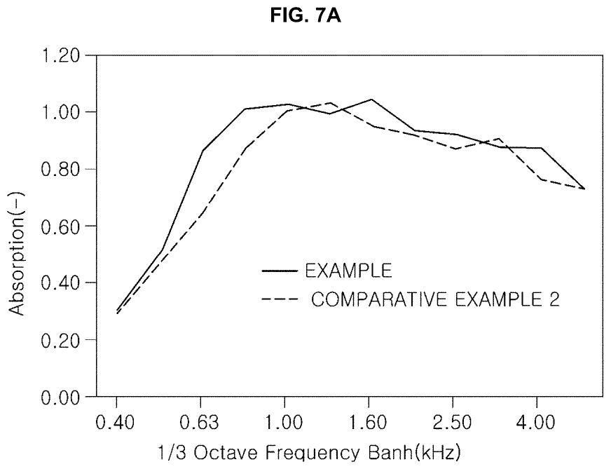

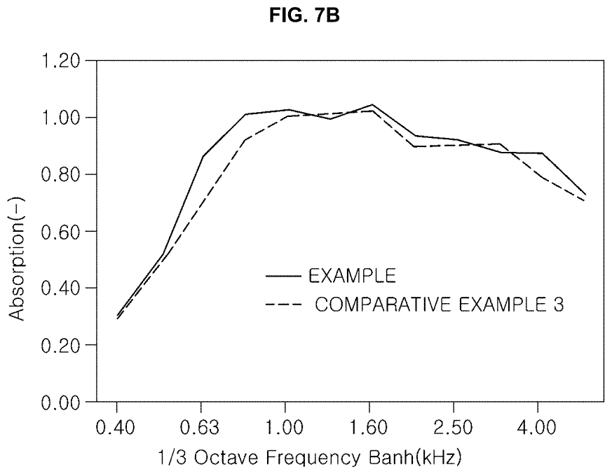

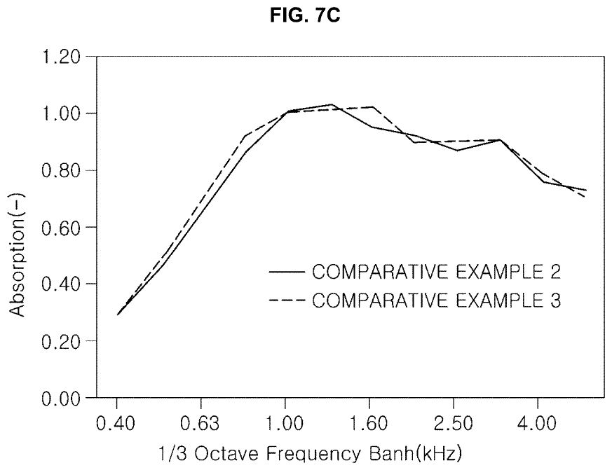

Next, a test in which sound absorption depending on whether or not a holey plate is present and the kind of the holey plate is detected was performed, and test results are represented in FIGS. 7A to 7C.

FIGS. 7A to 7C are graphs comparatively representing sound absorption depending on whether or not the holey plate is present and the kind of the holey plate.

A holey plate sample was prepared by forming first bent parts and second bent parts according to the present disclosure in an aluminum (Al) plate having a thickness of 125 μm.

Thereafter, PU foam of 18K and 25t serving as the sound absorbing material was bonded to the prepared holey plate sample using a holt melt film of 30 g/m² serving as an adhesive in an example.

Further, the PU foam of 18K and 25t serving as the sound absorbing material was used alone without a holey plate in comparative example 2, and the PU foam of 18K and 25t serving as the sound absorbing material was bonded to the conventional holey plate provided with the straight linear punched holes shown in FIG. 4B using the holt melt film of 30 g/m² serving as an adhesive in comparative example 3.

As shown in FIGS. 7A and 7B, it may be confirmed that sound absorption performance of the example in which the holey plate according to the present disclosure is used is improved by 5% or more in most frequency bands compared to comparative example 2 in which no holey plate is used and comparative example 3 in which the conventional punched plate is used.

Here, average sound absorption performance of the example was 0.84, and average sound absorption performance of comparative example 3 was 0.80.

In addition, as shown in FIG. 7C, it may be confirmed that sound absorption performance of comparative example 2 in which no holey plate is used and sound absorption performance of comparative example 3 in which the conventional punched plate is used are similar in most frequency bands.

These results show that the holey plate prepared by forming the first bent parts and the second bent parts according to the present disclosure may exhibit a sound absorption improvement effect which may not be expected in the case of the conventional punched plate.

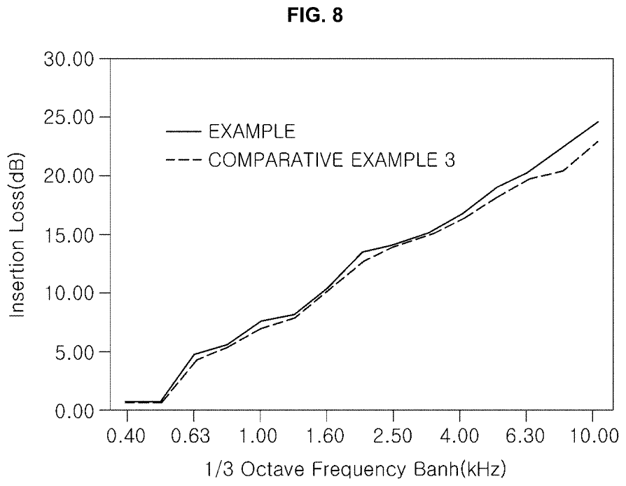

Next, a test in which sound insulation depending on the kind of a holey plate is detected was performed, and test results are represented in FIG. 8.

FIG. 8 is a graph comparatively representing sound insulation depending on the kind of the holey plate.

A holey plate sample was prepared by forming first bent parts and second bent parts according to the present disclosure in an aluminum (Al) plate having a thickness of 125 μm.

Thereafter, PU foam of 18K and 25t serving as the sound absorbing material was bonded to the prepared holey plate sample using a hot melt film of 30 g/m² serving as an adhesive in an example.

Further, the PU foam of 18K and 25t serving as the sound absorbing material was bonded to the conventional holey plate provided with the straight linear punched holes shown in FIG. 4B using the holt melt film of 30 g/m² serving as an adhesive in comparative example 3.

As shown in FIG. 8, it may be confirmed that sound insulation performance of the example in which the holey plate according to the present disclosure is used is improved by 5.1% on average in most frequency bands compared to comparative example 3 in which the conventional punched plate is used.

Here, an average noise reduction rate of the example was 12.30, and an average noise reduction rate of comparative example 3 was 11.67.

Therefore, it may be understood that, even if a holey plate having a given weight is prepared, sound insulation performance of the holey plate may be improved through change in the structure of punched holes formed in the holey plate.

As is apparent from the above description, in a holey plate and a composite panel for sound absorption and sound insulation using the same according to one embodiment of the present disclosure, sound absorption and sound insulation performance of the holey plate due to punched holes may be improved by adjusting the shape and size of the punched holes formed through a base part.

In addition, bonding strength of the holey plate and a sound absorbing material is improved by adjusting the angles of first bent parts and second bent parts, which are formed by the punched holes formed through the base part, with the base part, thereby being capable of increasing durability of the composite panel.

Although the exemplary embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A holey plate used in a composite panel for sound absorption and sound insulation, the holey plate comprising:
a base part;
first bent parts configured to be bent from designated regions of the base part and to extend to be inclined so as to form a plurality of first punched holes by punching the designated regions of the base part in a thickness direction; and
second bent parts configured to be bent from the first bent parts and to extend to be inclined so as to form second punched holes extending from the first punched holes, an angle of the second bent parts with the base part being smaller than an angle of the first bent parts with the base part.

2. The holey plate according to claim 1, wherein a thickness of the base part is 35-500 μm.

3. The holey plate according to claim 1, wherein a maximum inner diameter of the second punched holes is 0.15-1.5 mm.

4. The holey plate according to claim 1, wherein a maximum inner diameter of the first punched holes and a maximum inner diameter of the second punched holes satisfy an Equation: 1.5×D2≤D1≤5.0×D2, wherein D1 indicates the maximum inner diameter of the first punched holes and D2 indicates the maximum inner diameter of the second punched holes.

5. The holey plate according to claim 1, wherein a maximum inner diameter of the second punched holes and a height of the first bent parts satisfy an Equation: 0.3×D2≤H≤2.0×D2, wherein D2 indicates the maximum inner diameter of the second punched holes and H indicates the height of the first bent parts.

6. The holey plate according to claim 1, wherein the angle of the first bent parts with the base part is 120-170°.

7. The holey plate according to claim 1, wherein the first bent parts are formed to have a dome or conical shape.

8. The holey plate according to claim 1, wherein the base part is a plate-type.

9. A composite panel for sound absorption and sound insulation comprising:
a holey plate comprising a base part, first bent parts configured to be bent from designated regions of the base part and to extend to be inclined so as to form a plurality of first punched holes by punching the designated regions of the base part in a thickness direction, and second bent parts configured to be bent from the first bent parts and to extend to be inclined so as to form second punched holes extending from the first punched holes, an angle of the second bent parts with the base part being smaller than an angle of the first bent parts with the base part; and
a sound absorbing material configured to be bonded to a surface of the holey plate in a direction in which the first bent parts and the second bent parts are bent, among both surfaces of the holey plate, so as to absorb and insulate noise.

10. The composite panel for sound absorption and sound insulation according to claim 9, wherein the sound absorbing material is bonded to the surface of the holey plate in the direction in which the first bent parts and the second bent parts are bent, and outer circumferential surfaces of the first bent parts and the second bent parts, but is not disposed in the first punched holes and the second punched holes formed in inner circumferential regions of the first bent parts and the second bent parts, and the sound absorbing material closes ends of the second punched holes.

11. The composite panel for sound absorption and sound insulation according to claim 9, wherein the holey plate is formed of one of aluminum and stainless steel to have a thickness of 35-500 μm.

12. The composite panel for sound absorption and sound insulation according to claim 9, wherein the sound absorbing material comprises one or more of:
a thermosetting foaming body configured to have a density of 7-100 kg/cm³ and a thickness of 5-50 mm; and
felt comprising one or more of an olefin-based material, cotton fiber and an inorganic material and configured to have a unit weight of 100-2000 g/m².

13. The composite panel for sound absorption and sound insulation according to claim 9, wherein the base part is a plate-type.
